(19) United States
(12) Patent Application Publication
(10) Pub. No.: US 2019/0213646 A1
(43) Pub. Date: Jul. 11, 2019

(54) INFORMATION DISPLAY PROGRAM, DATA TRANSMISSION PROGRAM, DATA-TRANSMITTING APPARATUS, METHOD FOR TRANSMITTING DATA, INFORMATION-PROVIDING APPARATUS, AND METHOD FOR PROVIDING INFORMATION

(71) Applicant: Murata Manufacturing Co., Ltd., Kyoto (JP)

(72) Inventors: Masaharu ITAYA, Kyoto (JP); Yukihiko YAMAGATA, Kyoto (JP); Shinpei SASANO, Kyoto (JP); Yoshinari ISHIBASHI, Kyoto (JP)

(21) Appl. No.: 16/356,456

(22) Filed: Mar. 18, 2019

Related U.S. Application Data
(63) Continuation of application No. PCT/JP2017/033572, filed on Sep. 15, 2017.

(30) Foreign Application Priority Data
Sep. 29, 2016 (JP) 2016-190884

(51) Int. Cl. G06Q 30/02; G01C 21/36; G06Q 50/00

(52) U.S. Cl. CPC G06Q 30/0282; G06Q 50/01; G01C 21/3614

(57) ABSTRACT

A user is provided with information about the situation of a facility or a store in a specific area. An information display program provides a computer with a map display that displays a map on a screen, and a remark information display that displays pieces of remark information related to remarks each of which is detected at a position on the map such that each piece of remark information is associated with the position and superimposed on the map.

This is a continuation of International Application No. PCT/JP2017/033572 filed on Sep. 15, 2017 which claims priority from Japanese Patent Application No. 2016-190884 filed on Sep. 29, 2016. The contents of these applications are incorporated herein by reference in their entireties.

### BACKGROUND

### Technical Field

The present disclosure relates to an information display program, a data transmission program, a data-transmitting apparatus, an information-providing apparatus, and a method for providing information.

As social networking services (SNSs) and review sites are in more widespread use, users increasingly consult messages and evaluations of other people about a specific facility or store when the users decide their action. For example, a user considers visiting a facility for which a positive message is posted in a SNS or using a store highly rated in a review site in some cases. Patent Document 1 discloses a system that complementary uses states of a user and situations around the user to provide information in accordance with interests and likes of the user.

Patent Document 1: Japanese Unexamined Patent Application Publication No. 2012-256183

### BRIEF SUMMARY

In some cases, however, information from a SNS and a review site is difficult to use when a user searches a facility or a store to which the user will visit in the future in a specific area. For example, although it is possible to search a SNS message with a tag of the area, it is difficult to grasp which facility or store is good even when a list of messages extracted by the search is displayed. Another example is that, although information about facilities and stores in the area can be referred in a review site, the information from the review site was stored in the past, and the current situation cannot be grasped.

The present disclosure has been accomplished in view of the above circumstances, and the present disclosure provides a user with information about the situation of a facility or a store in a specific area.

An information display program according to an aspect of the present disclosure provides a computer with a map display that displays a map on a screen, and a remark information display that displays pieces of remark information related to remarks each of which is detected at a position on the map such that each piece of remark information is associated with the position and superimposed on the map.

A data transmission program according to an aspect of the present disclosure provides a computer with a sound collector that collects a sound, a remark detector that detects a remark in the collected sound, and a transmitter that transmits, to a server, collection data including remark data representing the detected remark and position data representing a position at which the sound is collected.

A data-transmitting apparatus according to an aspect of the present disclosure includes a sound collector that collects a sound, a remark detector that detects a remark in the collected sound, and a transmitter that transmits, to a server, collection data including remark data representing the detected remark and position data representing a position at which the sound is collected.

A method according to an aspect of the present disclosure for transmitting data by a computer includes detecting a remark in a collected sound, and transmitting, to a server, collection data including remark data representing the detected remark and position data representing a position at which the sound is collected.

An information-providing apparatus according to an aspect of the present disclosure includes a receiver that receives, from a data-transmitting apparatus, collection data including remark data representing a remark detected in a collected sound and position data representing a position at which the sound is collected and that stores the collection data in a collection data storage unit, and a transmitter that provides a user terminal with display data, based on the collection data, for displaying remark information related to the detected remark on a screen of the user terminal such that the remark information is associated with the position and superimposed on a map.

A method according to an aspect of the present disclosure for providing information by a computer includes receiving, from a data-transmitting apparatus, collection data including remark data representing a remark detected in a collected sound and position data representing a position at which the sound is collected, storing the collection data in a collection data storage unit, and providing a user terminal with display data, based on the collection data, for displaying remark information related to the detected remark on a screen of the user terminal such that the remark information is associated with the position and superimposed on a map.

According to the present disclosure, a user can be provided with information about the situation of a facility or a store in a specific area.

### BRIEF DESCRIPTION OF THE SEVERAL VIEWS OF THE DRAWINGS

FIG. 1 illustrates the structure of an information-providing system 100 according to an embodiment of the present disclosure.

FIG. 2 illustrates an example of a functional block of a data-transmitting apparatus 110.

FIG. 3 illustrates an example of a functional block of an information-providing apparatus 120.

FIG. 4 illustrates an example of a functional block of an information-displaying apparatus 130.

FIG. 5 illustrates an example of information that is displayed on a screen 500 of the information-displaying apparatus 130.

FIG. 6 is a flow chart illustrating an example of processes of the information-providing system 100.

FIG. 7 is a flow chart illustrating a process of updating a dictionary database.

### DETAILED DESCRIPTION

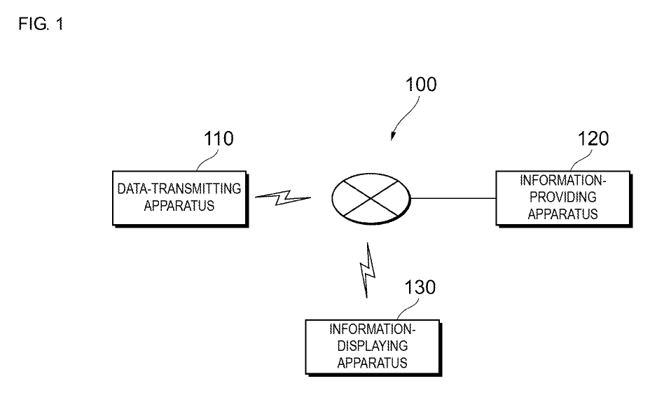

An embodiment of the present disclosure will hereinafter be described with reference to the drawings. FIG. 1 illustrates the structure of an information-providing system 100 according to the embodiment of the present disclosure. The information-providing system 100 includes data-transmitting apparatuses 110, an information-providing apparatus 120, and information-displaying apparatuses 130. The data-transmitting apparatuses 110, the information-providing apparatus 120, and the information-displaying apparatuses 130 are connected so as to be capable of communicating with each other via a network. In the information-providing system 100, a user of each information-displaying apparatus 130 is provided with information based on data that is transmitted from the data-transmitting apparatuses 110 to the information-providing apparatus 120. In FIG. 1, one of the data-transmitting apparatuses 110 and one of the information-displaying apparatuses 130 are illustrated. However, the information-providing system 100 includes a plurality of the data-transmitting apparatuses 110 and a plurality of the information-displaying apparatuses 130.

Each data-transmitting apparatus 110 is a computer that transmits, to the information-providing apparatus 120, data (collection data) that is collected at a position at which the data-transmitting apparatus 110 is disposed. The data-transmitting apparatus 110 may be a computer that is disposed in a facility or a store or may be a computer (for example, a smart phone or a tablet terminal) that a user who visits a facility or a store possesses. The data-transmitting apparatus 110 includes a processor, a memory, and a communication interface. The data-transmitting apparatus 110 can communicate with the information-providing apparatus 120 via, for example, a cellular phone communication network or the internet.

The information-providing apparatus 120 is a computer (server) that provides the user of each information-displaying apparatus 130 with information based on the data (collection data) that is received from the data-transmitting apparatus 110. The information-providing apparatus 120 includes a processor, a memory, and a communication interface. The information-providing apparatus 120 can communicate with the data-transmitting apparatus 110 and the information-displaying apparatus 130 via, for example, the internet.

Each information-displaying apparatus 130 is a computer (user terminal) that displays information based on data (display data) that is provided from the information-providing apparatus 120. Examples of the information-displaying apparatus 130 include a smart phone, a tablet terminal, and a personal computer. The information-displaying apparatus 130 includes a processor, a memory, and a communication interface. The information-displaying apparatus 130 can communicate with the information-providing apparatus 120 via, for example, the cellular phone communication network or the internet.

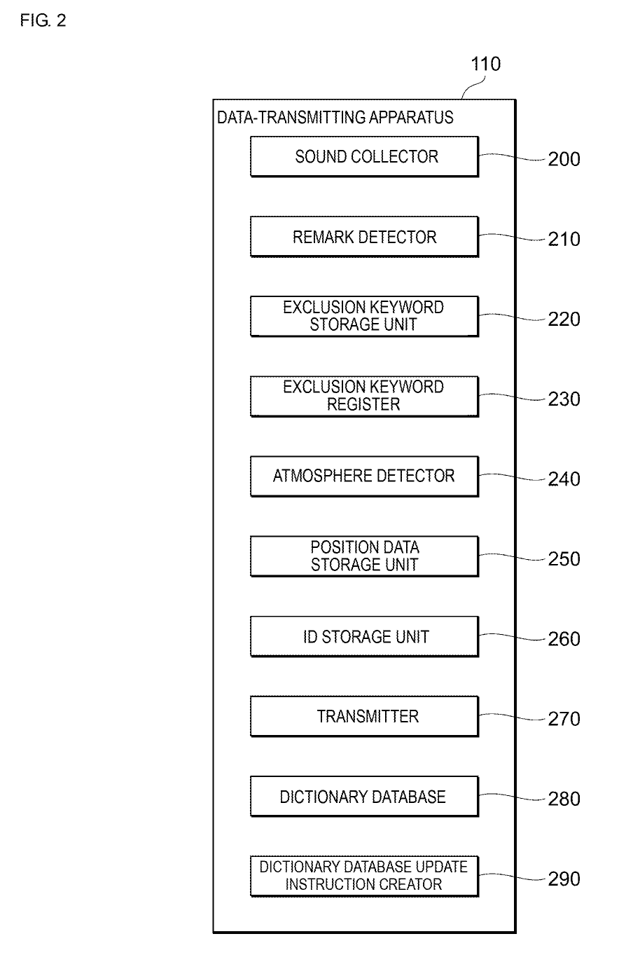

FIG. 2 illustrates an example of a functional block of each data-transmitting apparatus 110. The data-transmitting apparatus 110 includes a sound collector 200, a remark detector 210, an exclusion keyword storage unit 220, an atmosphere detector 240, a position data storage unit 250, an ID storage unit 260, a transmitter 270, a dictionary database 280, and a dictionary database update instruction creator 290. The components illustrated in FIG. 2 can be provided, for example, by using the memory of the data-transmitting apparatus 110 or by running a data transmission program that is stored in the memory by the processor. The data transmission program that is to run in the data-transmitting apparatus 110 is provided to the data-transmitting apparatus 110, for example, via a network or by using a storage medium. The data transmission program is read from a storage medium that can be read by the computer into the memory of the data-transmitting apparatus 110 and run by the processor of the data-transmitting apparatus 110.

The sound collector 200 collects a sound around the data-transmitting apparatus 110 with, for example, a microphone and outputs sound data. The sound collector 200 can keep collecting the sound while the data-transmitting apparatus 110 operates. The sound collector 200 may be a microphone that is contained in the transmitting apparatus 110 or an external microphone (external wired microphone or wireless microphone). For example, a tablet terminal to which the external microphone is connected functions as the data-transmitting apparatus 110. The data-transmitting apparatus 110 may include a plurality of the sound collectors 200. The data-transmitting apparatus 110 may detect relative positions of the sound collectors 200.

Based on the sound data, the remark detector 210 detects a person's remark near the data-transmitting apparatus 110 and outputs remark data representing the remark. The remark detector 210 can use any method to detect the remark. For example, the remark detector 210 can detect the remark in the collected sound by referring the dictionary database 280 in which meaningful keywords (phrases or words) are registered. The remark that is detected by the remark detector 210 may be a sentence or may be a word that is included in a sentence. Specifically, the remark detector 210 first analyzes the sound data and converts the sound into text data. The remark detector 210 compares the remark that is included in the text data with a keyword that is stored in advance in the dictionary database 280. When the remark that is included in the text data matches the keyword that is stored in advance in the dictionary database 280, the remark detector 210 outputs the keyword as the remark data. The remark detector 210 can keep outputting the remark data while the data-transmitting apparatus 110 operates. The remark detector 210 can include a buffer for temporarily storing the remark data generated.

The exclusion keyword storage unit 220 stores a keyword (exclusion keyword) that is excluded from the remark that is detected by the remark detector 210. Examples of the exclusion keyword include words related to a slander and a libel and words that are meaningless when the situation around the data-transmitting apparatus 110 is grasped.

An exclusion keyword register 230 can register the exclusion keyword that is to be stored in the exclusion keyword storage unit 220 in response to a user input. The exclusion keyword may be updated, for example, by using data that is transmitted from the information-providing apparatus 120.

Based on the sound data, the atmosphere detector 240 detects an atmosphere (e.g., an attitude, emotion, mood, and the like) around the data-transmitting apparatus 110 and outputs atmosphere data representing the atmosphere. The atmosphere detector 240 can use any method to detect the atmosphere. For example, based on the volume and intonation of the sound, a detection frequency, and the content of the remark, the atmosphere detector 240 can detect the atmosphere. For example, the atmosphere that is detected may be represented by using an axis as in the degree of emotional uplift or may be represented by using axes as in the Russell's emotion model and the Plutchik's emotion model. The atmosphere detector 240 can keep detecting the atmosphere while the data-transmitting apparatus 110 operates. The atmosphere detector 240 can include a buffer for temporarily storing the atmosphere data generated.

The atmosphere detector 240 may extract an indicator of the degree of affirmation or negation of the remark from the wave form of the sound data. For example, the atmosphere detector 240 can use Empath (registered trademark) to extract the indicator of the degree of affirmation or negation of the remark from the wave form of the sound data. The Empath analyzes physical characteristics of the wave form of the sound data and calculates fifty-grades determination values of items of normal, anger, joy, sorrow, and healthiness. Based on the calculation result, the atmosphere detector 240 can extract the indicator of the degree of affirmation or negation of the remark. The technique for calculating the determination values related to emotion or sentiment from the wave form of the sound data in this way is referred to as a sound sentiment analysis technique. Items that are determined by using the sound sentiment analysis technique are not limited to normal, anger, joy, sorrow, and healthiness and can include any item related to emotion. The atmosphere detector 240 can detect the atmosphere from the indicator of the degree of affirmation or negation of the remark in a manner in which the indicator of the degree of affirmation or negation of the remark is associated with the atmosphere in advance.

The position data storage unit 250 stores position data representing the position (position at which the sound is collected) of the data-transmitting apparatus 110. The position data can be any data that enables the information-providing apparatus 120 to specify the position of the data-transmitting apparatus 110. For example, the position data may be data (the latitude and the longitude) that is outputted from a GPS (Global Positioning System) receiver (not illustrated) of the data-transmitting apparatus 110. For example, the position data may be data representing the ID of a facility or a store.

The ID storage unit 260 stores a SNS ID. For example, when the data-transmitting apparatus 110 is a computer (a smart phone or a tablet terminal) that a user who visits a facility or a store possesses, the SNS ID is a user ID in a SNS in which the user is registered. For example, when the data-transmitting apparatus 110 is a computer that is disposed in a facility or a store, the SNS ID may be an ID that is registered in the data-transmitting apparatus 110 by a user when the user visits the facility or the store.

The transmitter 270 transmits, to the information-providing apparatus 120, collection data including the remark data representing the detected remark, the atmosphere data representing the detected atmosphere, and the position data representing the position at which the sound is collected. In the case where the SNS ID is stored in the ID storage unit 260, the collection data may include the ID. In the case where the SNS ID is stored in the ID storage unit 260, the transmitter 270 may transmit data for posting the remark to the SNS in addition to the collection data to the information-providing apparatus 120. The collection data may include time data representing the time at which the sound, the remark, or the atmosphere is collected or the time at which the collection data is generated. The transmitter 270 can keep transmitting the collection data, for example, at a regular interval while the data-transmitting apparatus 110 operates. The transmitter 270 may stop transmitting the collection data in the case where the sound is not detected.

The dictionary database update instruction creator 290 creates an instruction (dictionary database update instruction) for updating the dictionary database 280. The dictionary database update instruction is created at a certain opportunity. The certain opportunity may be the time at which the hit ratio of the dictionary database 280 decreases to less than a predetermined threshold or may be a predetermined regular interval. The hit ratio means a ratio of keywords that have been determined to be included in the sounds collected by the sound collector 200 to all of the keywords that are registered in the dictionary database 280. The transmitter 270 transmits the dictionary database update instruction that is created by the dictionary database update instruction creator 290 to the information-providing apparatus 120.

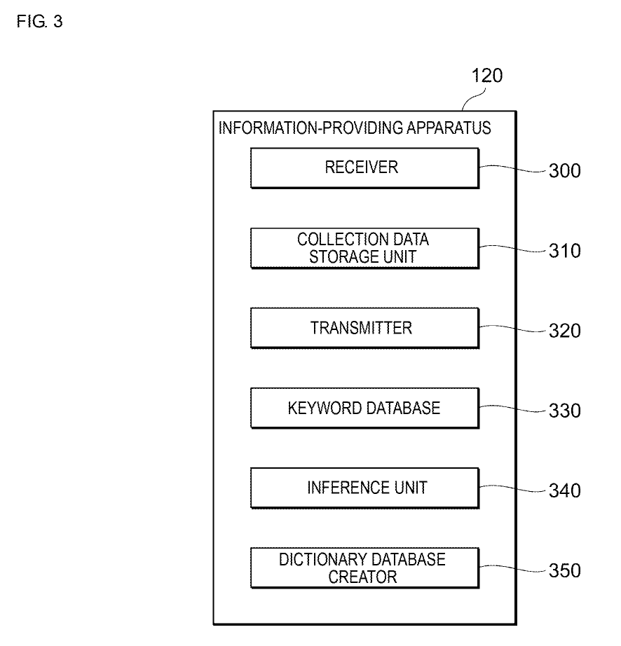

FIG. 3 illustrates an example of a functional block of the information-providing apparatus 120. The information-providing apparatus 120 includes a receiver 300, a collection data storage unit 310, a transmitter 320, a keyword database 330, an inference unit 340, and a dictionary database creator 350. The components illustrated in FIG. 3 can be provided, for example, by using the memory of the information-providing apparatus 120 or by running an information provision program that is stored in the memory by the processor. The information provision program that is to run in the information-providing apparatus 120 is provided to the information-providing apparatus 120, for example, via a network or by using a storage medium. The information provision program is read from a storage medium that can be read by the computer into the memory of the information-providing apparatus 120 and run by the processor of the information-providing apparatus 120.

The information-providing apparatus 120 may receive a keyword that is transmitted as the remark data from the data-transmitting apparatus 110, store the keyword, and infer a topic from the stored keyword. For example, when the keyword is a “handle”, a “brake”, or a “tire”, it can be inferred that the topic is related to a “vehicle”. The inferred topic is provided to, for example, an advertising agency. In addition, the information-providing apparatus 120 updates the dictionary database 280 in response to the dictionary database update instruction from the data-transmitting apparatus 110.

The receiver 300 receives the collection data that is transmitted from the data-transmitting apparatus 110 and stores the collection data in the collection data storage unit 310. For example, data that is collected during a certain period and that is needed to be provided to the information-displaying apparatus 130 is stored in the collection data storage unit 310. The receiver 300 receives the dictionary database update instruction that is transmitted from the data-transmitting apparatus 110.

The transmitter 320 provides the information-displaying apparatus 130 with the display data for displaying information on a screen of the information-displaying apparatus 130. Examples of the information that is displayed on the information-displaying apparatus 130 include a map, remark information, and atmosphere information. It is only necessary for the display data to be data for displaying such information on the information-displaying apparatus 130. The display data itself may include or may not include such information. For example, the display data may include image data or character data of such information or may include data (for example, a tag or a script) for obtaining the image data or the character data.

The keyword database 330 stores a keyword that is included in the collection data that is received by the receiver 300. The inference unit 340 infers a related word of the keyword that is stored in the keyword database 330 in response to the dictionary database update instruction that is received by the receiver 300. The related word of the keyword means a word that is frequently used together with the keyword, and such a word is referred to as a “co-occurrence word”. The co-occurrence word does not necessarily mean a synonym. An example of the inference unit 340 is a co-occurrence-word-searching tool that uses artificial intelligence. Examples of the co-occurrence-word-searching tool is a tool that performs morphological analysis of the content of a superordinate web page of a search result by, for example, Google or Yahoo and that presents a word that frequently appears in the same document as the co-occurrence word. The morphological analysis means a process of parsing natural-language text data that includes no notes on grammatical information into a row of morphemes (the smallest meaningful unit in a language) on the basis of information about the grammar of a target language or information about parts of speech of words that is referred to as a dictionary, and identifying, for example, the parts of speech of each morpheme.

The dictionary database creator 350 updates the dictionary database 280 in response to the dictionary database update instruction that is received by the receiver 300. Based on the keyword that is stored in the keyword database 330 and the related word that is inferred by the inference unit 340, the dictionary database creator 350 creates the updated dictionary database 280. In the updated dictionary database 280, a sound keyword that has been extracted from the sounds collected by the sound collector 200 and the related word thereof are registered as keywords. Among the keywords that are registered in the updated dictionary database 280, a sound keyword that has not extracted from the sounds collected by the sound collector 200 is deleted from the updated dictionary database 280. Repeating such an updating process enables the hit ratio of the dictionary database 280 to be increased.

The transmitter 320 transmits the updated dictionary database 280 to the data-transmitting apparatus 110. The data-transmitting apparatus 110 that receives the updated dictionary database 280 replaces the dictionary database 280 before updating with the updated dictionary database 280.

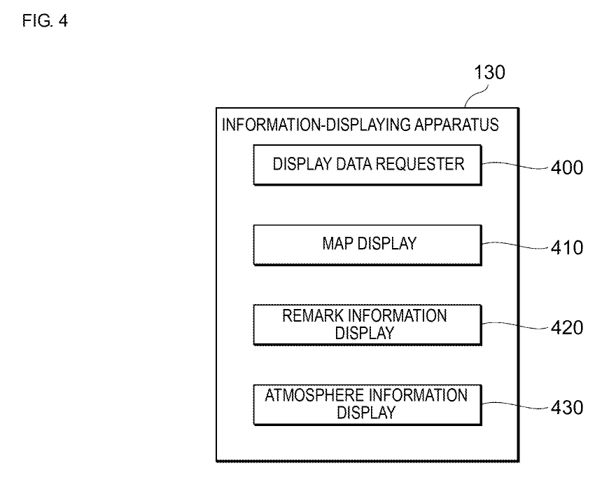

FIG. 4 illustrates an example of a functional block of each information-displaying apparatus 130. The information-displaying apparatus 130 includes a display data requester 400, a map display 410, a remark information display 420, and an atmosphere information display 430. The components illustrated in FIG. 4 can be provided, for example, by using the memory of the information-displaying apparatus 130 or by running an information display program that is stored in the memory by the processor. The information display program that is to run in the information-displaying apparatus 130 is provided to the information-displaying apparatus 130, for example, via a network or by using a storage medium. The information display program that is to run in the information-displaying apparatus 130 may be preinstalled in the information-displaying apparatus 130 or may be provided from, for example, the information-providing apparatus 120 (for example, HTML data or a script) when the information display program is run in the information-displaying apparatus 130. The information display program is read from a storage medium that can be read by the computer into the memory of the information-displaying apparatus 130 and run by the processor of the information-displaying apparatus 130.

The display data requester 400 requests an information display request for displaying information on the screen from the information-providing apparatus 120. Examples of the information display request include area data representing an area of the information that is to be displayed. Examples of the area data include position data (the latitude and the longitude) that is obtained from a GPS receiver and name data of an area, a facility, or another location that is inputted from a user.

Based on the display data that is transmitted from the information-providing apparatus 120 in response to the information display request, the map display 410 displays a map on the screen. The map display 410 may obtain map data from the information-providing apparatus 120 or may obtain the map data from another computer that differs from the information-providing apparatus 120.

Based on the display data that is transmitted from the information-providing apparatus 120 in response to the information display request, the remark information display 420 displays the remark information related to the remark that is detected at the position on the map such that the remark information is associated with the position and superimposed on the map. For example, the remark information includes a text representing at least a part of the remark. The remark information is not limited to a text and may be, for example, an icon image related to the content of the remark. The remark information display 420 may display information about a SNS (for example, an icon image of the SNS or the SNS ID of a person who remarks the remark) together with the remark information.

Based on the display data that is transmitted from the information-providing apparatus 120 in response to the information display request, the atmosphere information display 430 displays the atmosphere information related to the atmosphere that is detected at the position on the map such that the atmosphere information is associated with the position and superimposed on the map. The atmosphere information includes, for example, an image of a color related to the atmosphere. The color related to the atmosphere can be deeper red as the degree of emotional uplift becomes larger and deeper blue as the degree of emotional uplift becomes lower. In the case where the atmosphere is represented by axes, a color representing the degree of each axis may be used.

The map display 410, the remark information display 420, and the atmosphere information display 430 may not separately disposed.

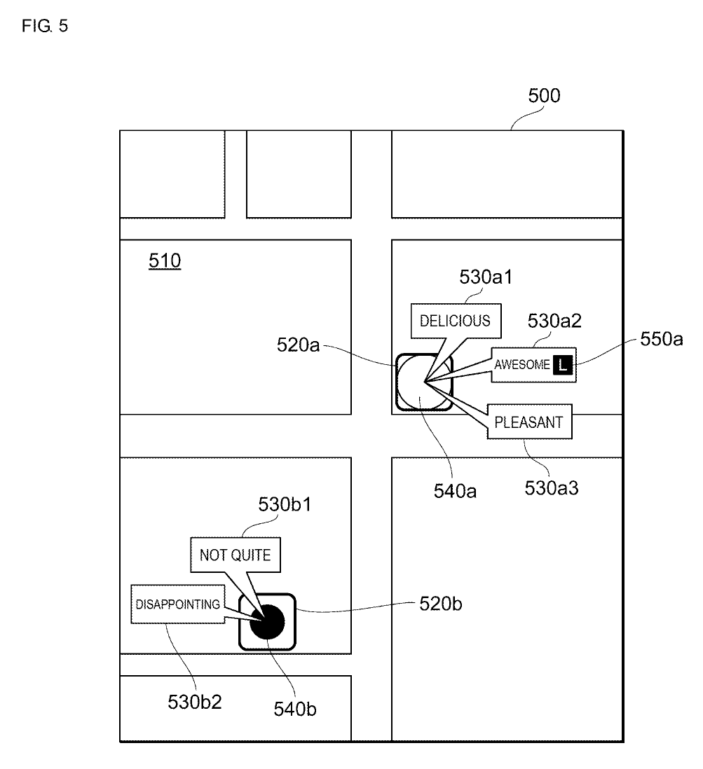

FIG. 5 illustrates an example of information that is displayed on a screen 500 of the information-displaying apparatus 130. As illustrated in FIG. 5, a map 510 is displayed on the screen 500. On the map 510, the area and the scale thereof can be freely changed, for example, in response to a user operation on the information-displaying apparatus 130. In the initial state, for example, an area specified by the position data that is obtained from the GPS receiver or the name data that is inputted from a user is displayed on the map 510. In an example illustrated in FIG. 5, the map 510 includes the position of stores 520. Atmosphere information 540 and remark information 530 related to remarks that are detected at positions on the map 510 are displayed so as to be superimposed on the map 510.

Specifically, remark information 530a1, 530a2, and 530a3 related to remarks that are detected at a store 520a and atmosphere information 540a related to an atmosphere that is detected at the store 520a are displayed so as to be associated with the position of the store 520a. In addition, remark information 530b1 and 530b2 related to remarks that are detected at a store 520b and atmosphere information 540b related to an atmosphere that is detected at the store 520b are displayed so as to be associated with the position of the store 520b.

The remark information 530 is displayed on the screen 500 for a predetermined time (for example, several seconds), for example, in order of detection of the remarks. Accordingly, regarding the stores 520 having many remarks, the remark information 530 appears and disappears one after another. The display time of the remark information 530 may be changed depending on the detection frequency of the corresponding remark. For example, when the detection frequency of the remark is high, the display time of the corresponding remark information 530 may be decreased.

In the example illustrated in FIG. 5, the atmosphere information 540a of the store 520a is displayed in white, and the atmosphere information 540b of the store 520b is displayed in black. This means that the degree of emotional uplift for the store 520a is high, and the degree of emotional uplift for the store 520b is low. In the example illustrated in FIG. 5, the size of the atmosphere information 540 is changed depending on the frequency with which the remarks are detected at the corresponding store 520. Similarly, the size of the remark information 530 may be changed depending on the frequency with which the remarks are detected at the corresponding store 520.

In the example illustrated in FIG. 5, the remark information 530 is displayed by balloons extending from the position of each store 520. However, the display form of the remark information 530 is not limited thereto provided that a relationship with the store 520 can be grasped. For example, the remark information 530 may be displayed so as to move on the screen 500 from the position of the store 520.

In the example illustrated in FIG. 5, a SNS icon image 550a is displayed together with the remark information 530a2. The SNS icon image 550a indicates that the SNS ID of a person who remarks the remark represented by the remark information 530a2 is disclosed. When a user clicks or taps the SNS icon image 550a, information about the SNS of the person (for example, attribution information or posting information) may be displayed.

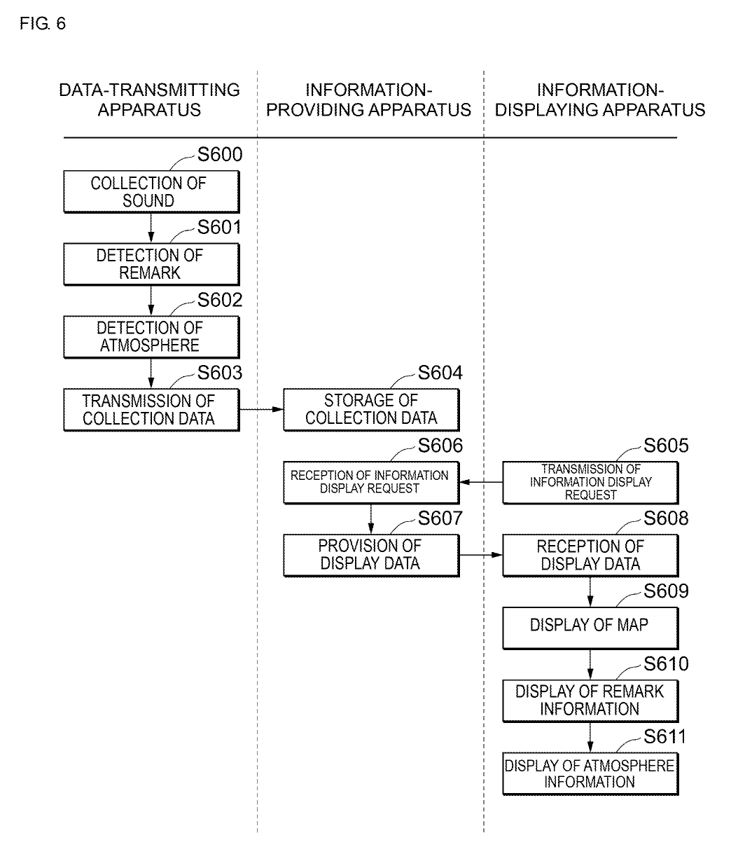

FIG. 6 is a flow chart illustrating an example of processes of the information-providing system 100.

The sound collector 200 of each data-transmitting apparatus 110 first collects a sound (S600). The remark detector 210 of the data-transmitting apparatus 110 detects a remark in the collected sound (S601). The atmosphere detector 240 of the data-transmitting apparatus 110 detects an atmosphere in the collected sound (S602). The transmitter 270 of the data-transmitting apparatus 110 transmits, to the information-providing apparatus 120, collection data including the remark data representing the detected remark, the atmosphere data representing the detected atmosphere, and the position data representing the position at which the sound is collected (S603).

The receiver 300 of the information-providing apparatus 120 receives the collection data that is transmitted from the data-transmitting apparatus 110 and stores the collection data in the collection data storage unit 310 (S604). The display data requester 400 of each information-displaying apparatus 130 transmits the information display request to the information-providing apparatus 120 in response to a user operation (S605). When the information display request is received (S606), based on the collection data that is stored in the collection data storage unit 310, the transmitter 320 of the information-providing apparatus 120 provides the information-displaying apparatus 130 with the display data related to the request (S607).

The display data requester 400 of the information-displaying apparatus 130 receives the display data that is transmitted from the information-providing apparatus 120 in response to the information display request (S608). Based on the display data, the map display 410 of the information-displaying apparatus 130 displays the map (S609). Based on the display data, the remark information display 420 of the information-displaying apparatus 130 displays the remark information such that the remark information is superimposed on the map (S610). Based on the display data, the atmosphere information display 430 of the information-displaying apparatus 130 displays the atmosphere information such that the atmosphere information is superimposed on the map (S611).

The above processes are repeated in the data-transmitting apparatus 110, the information-providing apparatus 120, and the information-displaying apparatus 130.

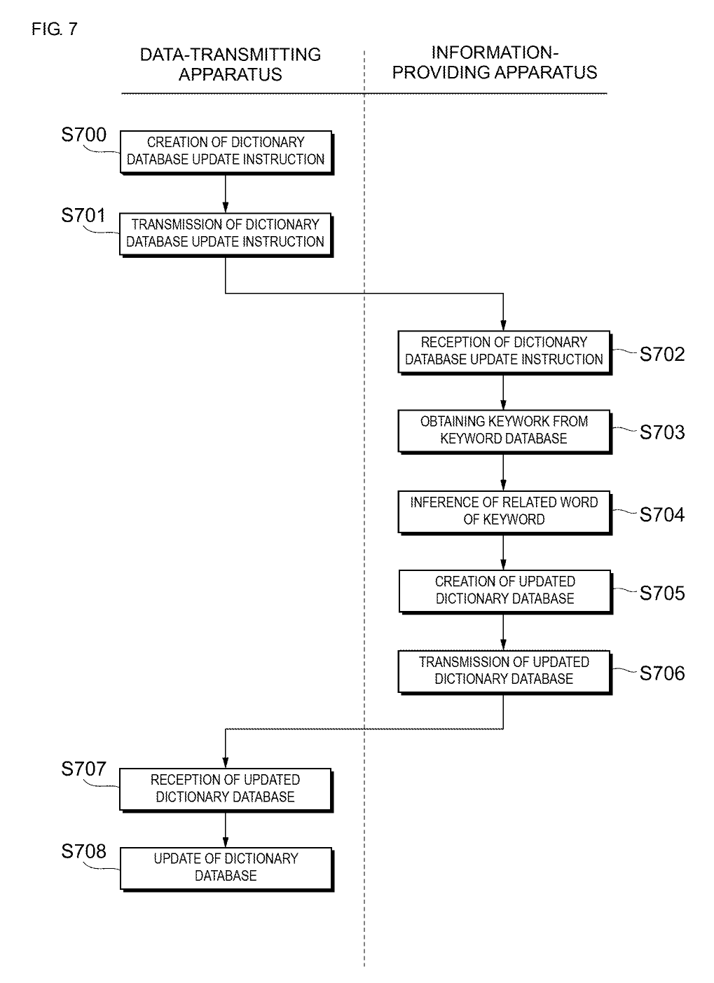

The flow of the process of updating the dictionary database will now be described with reference to FIG. 7. Each data-transmitting apparatus 110 creates the dictionary database update instruction at a certain opportunity (S700) and transmits the dictionary database update instruction to the information-providing apparatus 120 (S701). When the information-providing apparatus 120 receives the dictionary database update instruction (S702), the information-providing apparatus 120 obtains the keyword from the keyword database 330 (S703) and infers the related word of the keyword (S704). Subsequently, based on the keyword and the related word, the information-providing apparatus 120 creates the updated dictionary database 280 (S705) and transmits the updated dictionary database to the data-transmitting apparatus 110 (S706). When the data-transmitting apparatus 110 receives the updated dictionary database 280 (S707), the data-transmitting apparatus 110 replaces the dictionary database 280 before updating with the updated dictionary database 280 to update the dictionary database 280 (S708).

The embodiment of the present disclosure is described above by way of example. According to the embodiment, the remark information related to each remark detected at the position on the map is displayed such that the remark information is associated with the position and superimposed on the map. This enables the situation of the corresponding facility or store to be grasped in real time on the basis of the remark information representing the remark for the facility or store in a specific area.

According to the embodiment, the remark information can include a text representing a part of the remark. This enables the specific content of the remark for the facility or the store to be grasped.

According to the embodiment, pieces of the remark information can be displayed on the map in order of detection of the remarks. This enables the transition of the remarks to be grasped.

According to the embodiment, the pieces of the remark information can be erased after a predetermined time elapses since display of the pieces of the remark information on the map. This enables many pieces of the remark information to be displayed one after another in a limited display region.

According to the embodiment, the time during which the remark information is displayed on the map can be changed depending on the frequency with which the remarks are detected. This enables the remark information to be effectively displayed, for example, depending on the frequency with which the remarks are detected.

According to the embodiment, the size of the remark information can be changed depending on the frequency with which the remarks are detected. For example, this enables the degree of emotional uplift for the facility or store to be intuitively grasped.

According to the embodiment, when the remark information is selected on the screen, information about the SNS of a person who remarks the remark can be displayed. This enables a user to identify a person who remarks a concerned remark and to see other remarks of the person in the SNS.

According to the embodiment, the atmosphere information related to the atmosphere detected at the position on the map is displayed such that the atmosphere information is associated with the position and superimposed on the map. This enables the atmosphere of the facility or store to be grasped in real time on the basis of the atmosphere information representing the atmosphere of the facility or store in a specific area.

According to the embodiment, the atmosphere information can include an image of a color related to the atmosphere. This enables the atmosphere of the facility or store to be intuitively grasped.

According to the embodiment, the size of the atmosphere information can be changed depending on the frequency with which the remarks are detected. For example, this enables the degree of emotional uplift for the facility or store to be intuitively grasped.

According to the embodiment, a specific keyword included in the sound can be prevented from being extracted as the remark. For example, this enables words related to a slander and a libel and meaningless words to be excluded.

According to the embodiment, the specific keyword can be registered. For example, this enables meaningless words for a specific facility or store to be excluded.

According to the embodiment, the SNS ID of a person who remarks the remark can be transmitted together with the collection data. This enables the remark and information about the SNS to be seen by using, for example, a user terminal. The detected remark may be automatically posted to the SNS to reduce time and effort to post the remark to the SNS.

The hit ratio of the dictionary database 280 can be increased in a manner in which the dictionary database 280 is updated based on the keyword that is extracted from the sounds collected by the sound collector 200 and that matches the keyword that is registered in the dictionary database 280, and the related word thereof. This enables the dictionary database 280 to be optimized. The optimization of the dictionary database 280 enables whether a product or a service is practically popular to be appropriately determined based on the sounds (for example, a real voice of a customer) that are collected by the sound collector 200. Each sound that is collected by the sound collector 200 is an actual sound that is collected at the position at which the corresponding data-transmitting apparatus 110 is disposed. Accordingly, whether a product or a service is practically popular can be determined, not based on evaluation on the internet but based on evaluation in the real world. In the case where the dictionary database 280 is repeatedly updated, unnecessary keywords are deleted from the dictionary database 280. Accordingly, the storage capacity of the dictionary database 280 may be small. This enables the size of the data-transmitting apparatus 110 and power consumption to be decreased.

The embodiment is described above to make the present disclosure easy to understand and does not limit the present disclosure. The present disclosure can be modified and altered without departing from the spirit thereof. The present disclosure includes equivalents. That is, an embodiment obtained by appropriately modifying the embodiment by a person skilled in the art is included in the scope of the present disclosure provided that the embodiment has the features of the present disclosure. For example, the arrangement, material, conditions, shape, and size of the components according to the embodiment are not limited to those described above by way of example and can be appropriately changed. The components according to the embodiment can be combined provided that the combination can be technically possible. The combination is also included in the scope of the present disclosure provided that the combination includes the features of the present disclosure.

### REFERENCE SIGNS LIST

100 information-providing system
110 data-transmitting apparatus
120 information-providing apparatus
130 information-displaying apparatus
200 sound collector
210 remark detector
220 exclusion keyword storage unit
240 atmosphere detector
250 position data storage unit
260 ID storage unit
270 collection data transmitter
300 receiver
310 collection data storage unit
320 transmitter
400 display data requester
410 map display
420 remark information display
430 atmosphere information display
500 screen
510 map
520 store
530 remark information
540 atmosphere information
550 SNS icon

1. A method for providing information comprising:
receiving, from a data-transmitting apparatus, collection data, the collection data including remark information and position information representing a position at which the remark information pertains;
storing the collection data; and
displaying a map on a user terminal based on the collection data, the remark information being superimposed on the map at a position of the map associated with the corresponding position information.

2. The method according to claim 1, wherein the remark information includes text representing at least one corresponding remark.

3. The method according to claim 1, wherein each remark of the remark information is erased from the display after a predetermined time on the display.

4. The method according to claim 3, wherein the predetermined time depends on a frequency with which remarks of the remark information at the position are received.

5. The method according to claim 1, wherein a display size of remark of the remark information changes such that each remark is associated with the position depending on a frequency with which the remarks at the position are received.

6. The method according to claim 1, wherein, when each remark is selected on the screen, the display further displays information about a social networking service of a person who made the remark.

7. The method according to claim 1, wherein the collection data further comprises atmosphere information related to an atmosphere at the position of each remark of the remark information, and the atmosphere information is superimposed at a position of the map associated with the position.

8. The method according to claim 7, wherein the atmosphere information includes an image of a color related to the atmosphere.

9. The method according to claim 7, wherein a size of the displayed atmosphere information changes such that the atmosphere information is associated with the position depending on a frequency with which the remarks at the position are received.

10. The method according to claim 1, wherein the remark information includes remarks detected from a collected sound at the position.

11. A data transmission method comprising:
collecting a sound at a position,
detecting a remark made in the collected sound, and
transmitting, to a server, collection data including remark information representing the detected remark and position information representing the position at which the sound is collected.

12. The method according to claim 11,
further comprising detecting an atmosphere at the location based on the collected sound, wherein the collection data further includes atmosphere information representing the detected atmosphere.

13. The data transmission program according to claim 11, wherein the remark is detected without extracting a specific keyword included in the collected sound as the remark.

14. The data transmission program according to claim 13, wherein the specific keyword is registered in an exclusion keyword register.

15. The data transmission program according to claim 11, further comprising transmitting a social networking service ID of a person who made a remark of the remark information.

16. The information-providing apparatus according to claim 11, wherein, when the remark includes a keyword that is registered in a dictionary database, the keyword is transmitted as the remark information.

17. The information-providing apparatus according to claim 16, further comprising updating the dictionary database to include a word related to the keyword based on an inference of the related word.
